(19) United States
(12) Patent Application Publication
(10) Pub. No.: US 2015/0204531 A1
(43) Pub. Date: Jul. 23, 2015

(54) LAMP WITH PRINTED CIRCUIT BOARDS

(71) Applicant: M.D. SRL, Loreto (AN) (IT)

(72) Inventor: Diego Pietrella, Loreto (AN) (IT)

(73) Assignee: M.D. SRL, Loreto (AN) (IT)

(21) Appl. No.: 14/419,082

(22) PCT Filed: Jul. 26, 2013
(86) PCT No.: PCT/EP2013/065852

§ 371 Date: Feb. 2, 2015

(30) Foreign Application Priority Data
Aug. 31, 2012 (IT) AN2012A000099

(51) Int. Cl. F21V 23/06; F21V 23/04; F21V 21/00

(52) U.S. Cl. CPC F21V 23/06; F21V 21/00; F21V 23/04

(57) ABSTRACT

A lamp has a base PCB, at least one support PCB connected to the base PCB, a lighting assembly connected to the support PCB and at least one light source and power supply connected to conductive tracks of the base PCB.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present patent application for industrial invention relates to a lamp with printed circuit boards.

2. Description of Related Art Including Information Disclosed Under 37 CFR 1.97 and 37 CFR 1.98.

Various types of lamps are known on the market, which are designed in such manner not to show the cables used to power the light source.

The U.S. Pat. No. 3,790,773 patent application discloses a lamp comprising a stem and a plurality of arms connected to each other and disposed in succession. Each arm of the lamp is connected to the consecutive arm in an articulated manner at intermediate points.

Said lamp comprises a terminal arm in remote position with respect to the stem. The terminal arm is provided with a first end and a second end. The first end of the terminal arm supports a light source and its relative accessories. The second end of the terminal arm supports a counterweight arranged in such a way as to balance the weight of the light source and said accessories.

These types of lamps according to the prior art are impaired by some drawbacks related with high production and installation costs, heavy weight due to the metal material used, overheating of arms and false electrical contacts inside the arms.

DE 39 03 202 discloses a lamp obtained with flat plate-shaped supports. Each flat support comprises a plate made of insulating material arranged between two plates of conductive material. This type of flat support is not a printed circuit board (PCB). The plates of conductive material are not the typical copper tracks that make up the PCB printed circuit. Moreover, such a flat support is not provided with holes with conductive metallization, such as the typical metalized holes of PBC's, which are known as “pads”.

Consequently, the following operations are necessary to connect two flat supports by means of a hinge:

making a hole on each flat support,
inserting an insulating bush into the hole,
inserting a conductive pin into the insulating bush to electrically connect the two conductive plates in external position, and
arranging a conductive ring onto the insulating bush to electrically connect the two conductive plates in internal position.

It appears evident that such a type of connection is complicated and not very reliable, especially because it must be provided with a conductive pin.

The purpose of the present invention is to eliminate the aforementioned drawbacks of the prior art by devising a lamp that is extremely easy to handle, light, inexpensive and easy to make.

Another purpose of the present invention is to provide a lamp wherein all electrical connections adapted to power the light source are made in a simple, reliable way.

These purposes are achieved according to the invention, with characteristics claimed in the attached independent claim 1.

Advantageous embodiments appear from the dependent claims.

### BRIEF SUMMARY OF THE INVENTION

The lamp of the invention comprises a base PCB, at least one support PCB connected to the base PCB, a lighting assembly connected to the support PCB and comprising at least one light source.

The base PCB comprises two conductive tracks connected to an electrical power supply and ending in two electrical contacts in contact with corresponding first electrical contacts of said at least one support PCB.

Said at least one support PCB comprises at least one conductive track connected to said first electrical contact of the support PCB and ending in a second electrical contact of the support PCB. Said second electrical contacts of said at least one support PCB are electrically connected with corresponding electrical contacts of said lighting assembly.

The electrical contacts of the base PCB and of said at least one support PCB are conductive metallizations obtained around a hole of the base PCB and around a first hole and a second hole of the support PCB, which go in mutual contact establishing the electrical connection between the tracks of the base PCB and the tracks of the support PCB.

The advantages of the lamp of the invention are evident. In fact, this lamp uses printed circuit boards to create the support frame and at the same time transport the electrical current from the power supply unit to the lighting assembly.

Advantageously, said printed circuit boards provide the lamp with a lower weight, a lower volume and a lower cost compared to the lamps of the prior art, as well as with reliable transmission of the electrical current and reliable insulation of electrical contacts.

In particular, metallizations of the holes on the printed circuit boards are used as electrical contacts between the two boards. This provides simpler and faster assembly and avoids the use of conductive pins to connect two boards with consequent problems in terms of safety and reliability.

### BRIEF DESCRIPTION OF THE DRAWINGS

Further characteristics of the invention will appear clearer from the detailed description below, which refers to merely illustrative, not limiting, embodiments, illustrated in the attached drawings, wherein:

FIG. 1 is an axonometric view of the lamp of the invention;

FIG. 2 is an exploded perspective view of the various parts of the lamp of FIG. 1;

FIG. 3 is an exploded plan view of the various parts of the lamp of FIG. 1;

FIG. 4 is a plan view showing three parts of FIG. 3 seen from the opposite side with respect to FIG. 3;

FIG. 4A is an enlarged view of a portion of FIG. 4, showing a metallization pad;

FIG. 5 is a perspective view of a portion of the lamp of FIG. 1;

FIG. 6 is a cross-sectional view along sectional plane VI-VI of FIG. 4A; and

FIG. 7 is a cross-sectional view along sectional plane VII -VII of FIG. 4.

### DETAILED DESCRIPTION OF THE INVENTION

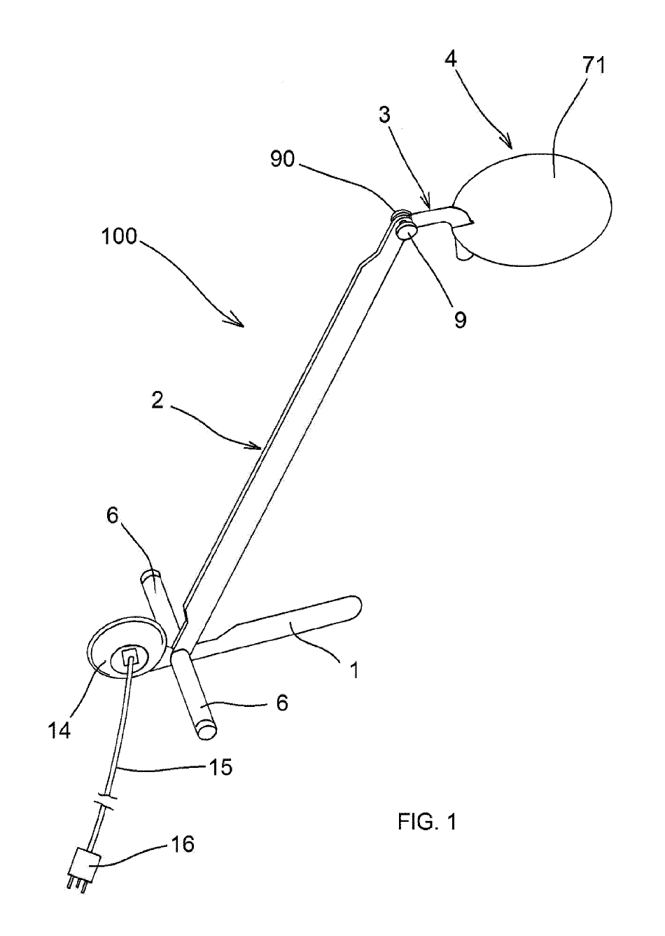

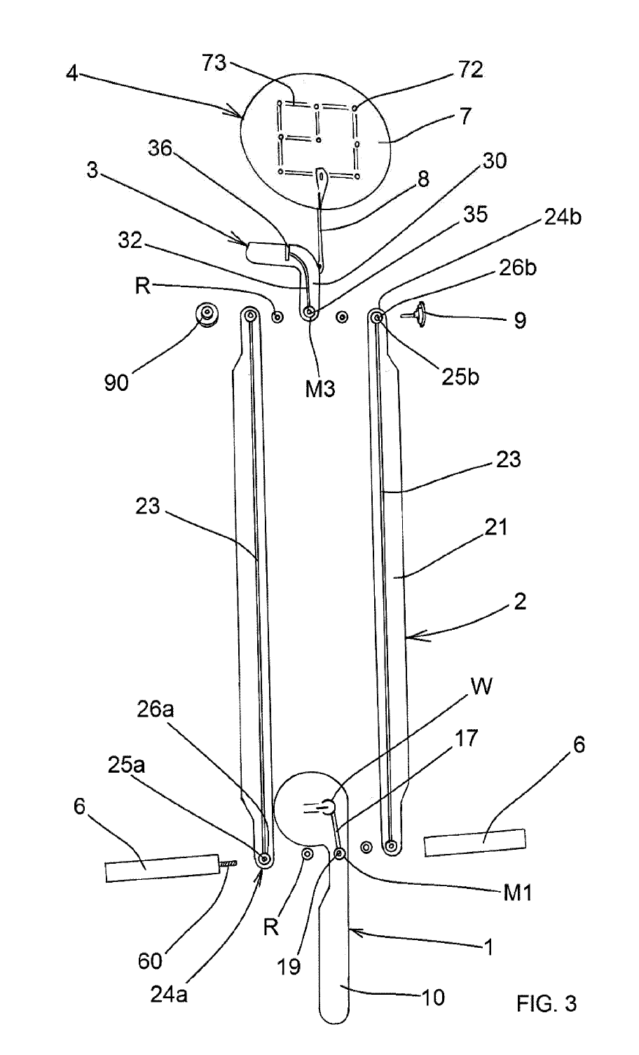

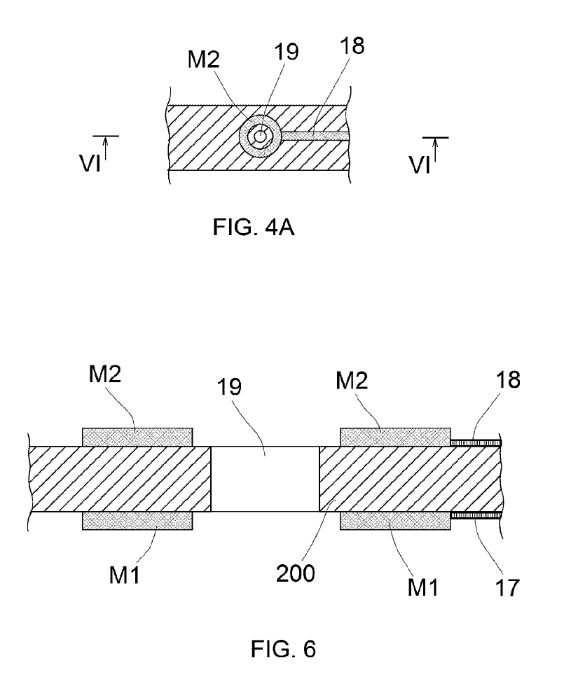

Referring to FIGS. 1-3, the lamp (100) of the invention comprises a base printed circuit board (PCB) (1), two support PCB's (2), one connection PCB (3) and one lighting assembly (4) provided with light source (5) (FIG. 5).

The base PCB (1), the two support PCB's (2) and the connection PCB (3) form the bearing frame of the lighting assembly (4).

Said base PCB (1) comprises a front side (10) accessible for the user and a back side (11). Moreover, the base PCB (1) comprises a circular portion (12) and an elongated portion (13) with substantially rectangular section.

On the back side (11) of the circular portion (12) of the base PCB (1) an electronic circuit (I) is mounted, which uses a power supply unit to power the lighting assembly (4). Said electronic circuit (I) is covered with a lid (14).

A power cord (15) passes through the lid (14) and is connected to the electronic circuit (I). The power cord (15) comprises a plug (16) for connection to the electrical mains.

The electronic circuit (I) is optional. In such a case, the electrical power cord (15) is connected directly to the printed circuit of the base PCB (1).

Referring to FIG. 5, the light source (5) comprises at least one LED. In such a case, the integrated circuit (I) used to power the lighting assembly (4) is provided with a transformer to transform mains alternate current into direct current to power the LED's (5).

The light source (5) can also comprise incandescent, halogen or gas discharge lamps. In these cases, the integrated circuit (I) provides power for this type of light sources.

Alternatively to the power cord (15) and plug (16), power can be supplied to the lighting assembly (4) by batteries arranged inside the lid (14) and connected to the integrated circuit (I).

The integrated circuit (I) comprises a positive power output and a negative power output respectively connected to a positive track (17) and a negative track (18) obtained on the base PCB (1). The tracks (17, 18) are generally made of copper and form part of the board printed circuit.

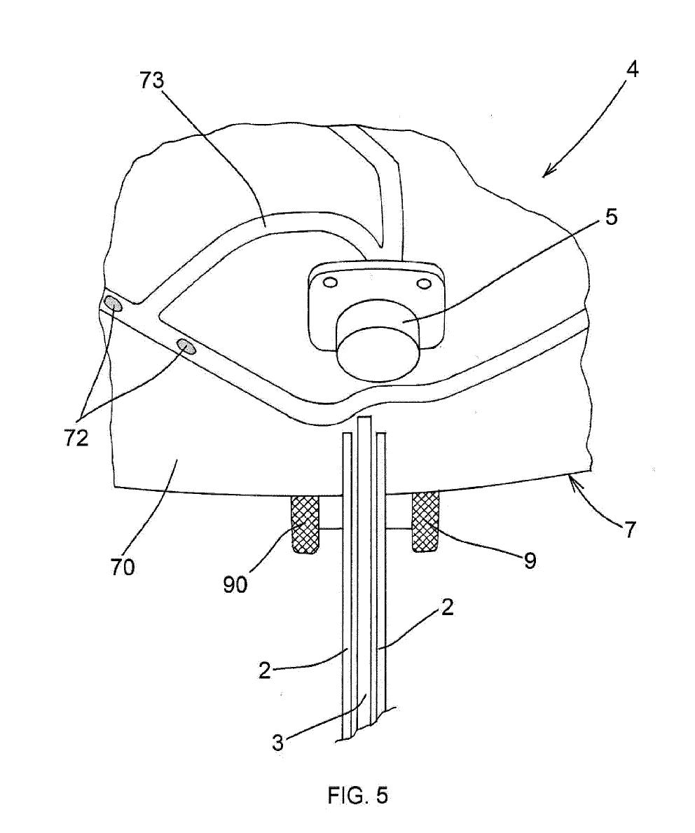

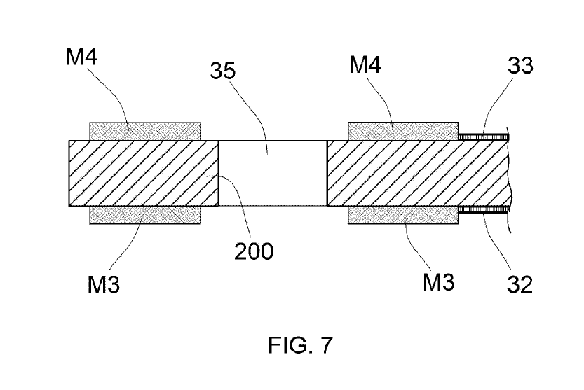

Advantageously, the base PCB (1) is double-sided, meaning that it provides for two printed circuits respectively on the front side (10) and the back side (11) insulated by an insulating layer (200) (as shown in FIGS. 6 and 7). In such a case, the positive track (17) is part of the printed circuit obtained on the front side (10) of the base PCB, whereas the negative track (18) is part of the printed circuit on the back side (11) of the base PCB.

The circular portion (12) of the front side (10) of said base PCB (1) is provided with a switch (W) adapted to be actuated manually by the user in order to switch the lamp (100) on and off. For example, the switch (W) opens and closes the positive track (17) of the power supply. Advantageously, said switch (W) is a touch button.

The base PCB (1) has a hole (19) arranged on the elongated portion (13) close to the circular portion (12). The positive track (17) and the negative track (18) of the base PCB (1) end in the hole (19).

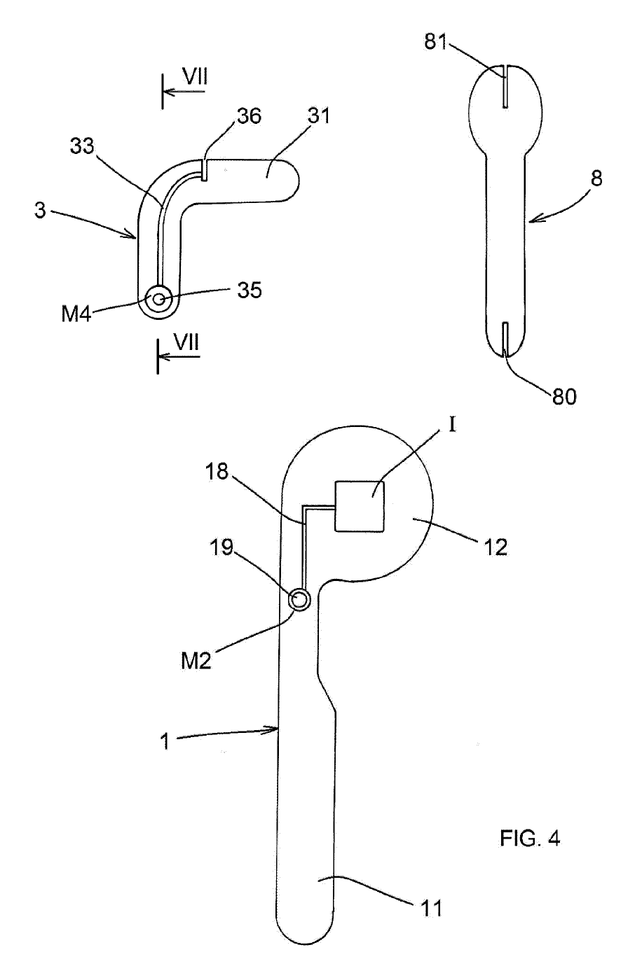

Referring to FIGS. 4A and 6, the hole (19) has two metallizations (M1, M2), normally defined as “pads”, connected respectively to the positive track (17) and the negative track (18). Pads (M1, M2) are rings of conductive material that surround the hole (19) on the front side (10) and the back side (11). Evidently, metallizations (M1, M2) are insulated to avoid short circuit. In fact, the insulating material (200) of the PCB provides insulation of metallizations (M1, M2).

Each support PCB (2) comprises an outwards-facing external side (20) and an internal side (21). The internal sides (21) of the two support PCB's (2) are in opposite position.

Each support PCB (2) is a single-sided printed circuit board, meaning that the printed circuit is obtained only on the internal side (21) of the board. In particular, each support PCB (2) is provided with conductive tracks (23) on the internal side (21).

Evidently, only one double-sided support PCB (2) can be provided, wherein the two conductive tracks (23) are obtained on the two sides of the support PCB. Alternatively, the support PBC can be of single-sided type, and in such a case the two conductive tracks (23) are obtained on the same side and insulated.

Each support PCB (2) has a substantially rectangular elongated shape and comprises a lower end (24a) and an upper end (24b).

Each support PBC (2) is provided with two holes (25a, 25b) arranged respectively in the proximity of the lower end (24a) and the upper end (24b) of the support PCB. The holes (25a, 25b) arranged in correspondence of the lower and upper end of each support PCB are provided with pads (26a, 26b) acting as electrical contacts. The pads (26a, 26b) of the two holes of each support PCB are connected to the track (23).

The base PCB (1) is arranged between the lower ends (24a) of the two support PCB's, in such manner that the pads (M1, M2) of the base PCB are in contact with the pads (26a) of the support PCB's. In view of the above, the pad (26a) close to the lower end (24a) of each support PCB acts as electrical contact to transfer the electrical current from the pads (M1, M2) of the base PCB (1) to the conductive tracks (23) of the support PCB's (2).

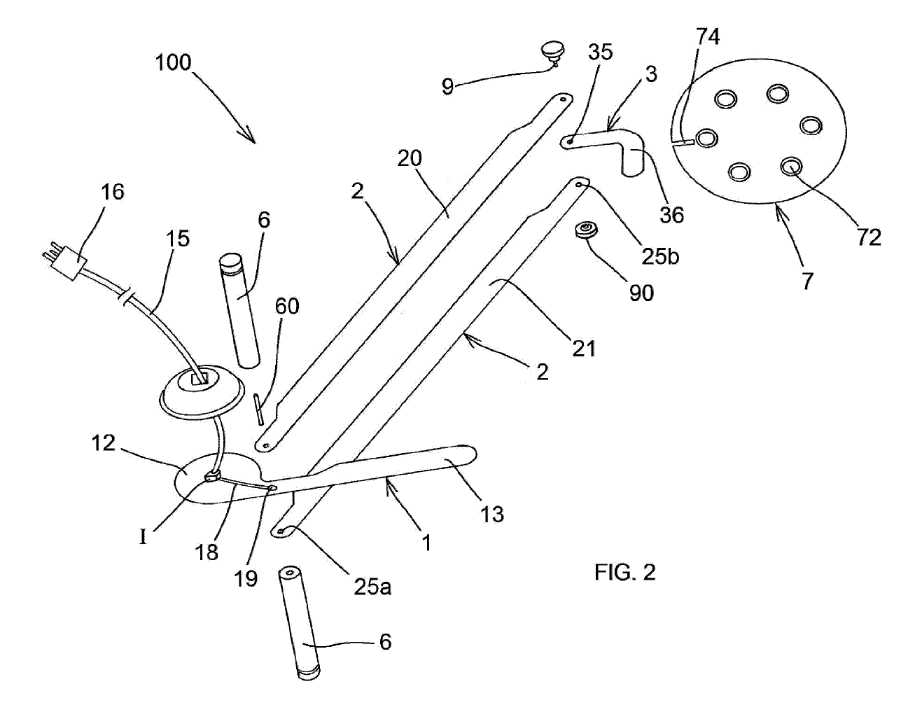

Referring to FIG. 2, the two support PCB's (2) are fixed to the base PCB (1) through a threaded plug (60) inserted in correspondence of the hole (19) of the elongated part (13) of said base PCB (1) and the holes (25a) of the lower ends of the support PCB.

Two conductive washers (R) are arranged between the pads (M1 , M2) of the hole of the base PCB and the pads (26a) of the two support PCB's. Said washers (R) contribute to improve electrical conduction and at the same time improve the fixing of the base PCB (1) to the two support PCB's (2) avoiding relative rotations between them.

Two cylindrical pins (6) are screwed onto the plug (60) in such manner to compress the support PCB's (2) and provide electrical contact between the pads (M1, M2, 26a) of the base PCB and the support PCB's and the washers (R). The cylindrical pins (6) protrude in opposite directions with respect to the support PCB's (2) in such manner that the base PCB (1) and cylindrical pins (6) assembly forms a cross acting as support base for the lamp (100) on a horizontal surface.

Advantageously the plug (60) and pins (6) can be made of non-conductive material because electrical connection is provided by the pads (M1, M2, 26a).

The connection PCB (3) substantially has an L-shape and comprises a front side (30) and a back side (31).

Advantageously, said connection PCB (3) is double-sided, meaning that it is provided with a conductive track (32) on the front side (30) and a conductive track (33) on the back side (31). The conductive tracks (32, 33) are insulated by an insulating layer.

The connection PCB (3) has a first end (34) arranged between the upper ends (24b) of said support PCB's (2).

In particular, in correspondence of said end (34) of the connection PCB (3) a hole (35) is provided and disposed in register with the holes (25b) in correspondence of the upper ends (24b) of the support PCB's (2).

Referring to FIG. 7, the hole (35) of the connection PCB is provided with two pads (M3, M4) respectively connected to the track (32) of the front side (30) and the track (33) of the back side of the connection PCB. Pads (M3, M4) are rings of conductive material that surround the hole (35) on the front side (30) and the back side (31). Evidently, pads (M3, M4) are insulated to avoid short circuit.

The pads (M3, M4) of the connection PCB receive the electrical current transported by the conductive tracks (23) ending into the hole (25b) of the two support PCB's.

The two support PCB's (2) are fixed to the connection PCB (3) by means of a screw (9) inserted in correspondence of the hole (35) of the connection PCB (3) and the holes (25b) of the upper ends of the support PCB. The screw (9) has a head and a threaded stem screwed into a threaded hole of a metal ring (90). In this way the two support PCB's (2) are compressed between the head of the screw (9) and the metal ring (90).

Two conductive washers (R) are arranged between the pads (M3, M4) of the hole of the connection PCB and the pads (26b) of the two support PCB's.

By screwing the screw (9) into the metal ring (90), the support PCB's (2) are compressed on the connection PCB (3) in such manner to provide electrical contact between the pads (M3, M4, 26b) of the connection PCB and the support PCB's and the washers (R).

Advantageously, the screw (9) and the metal ring (90) can be made of non conductive material because electrical connection is provided by the contact between metallizations (M3, M4, 26b).

The fact that the plug (60), the pins (6), the screw (9) and the metal ring (90) are made of non conductive material contributes to improve the lamp safety and reliability.

The connection PCB (3) is provided with a notch (36) with two pads respectively connected to the two tracks (32, 33) of the connection PCB. Said notch (36) is used to connect the lighting assembly (4).

The lighting assembly (4) comprises a PCB (7) to support the light source (5). The PCB (7) of the lighting assembly comprises a front side (70) wherein the light source (5) is arranged, and a back side (71) adapted to remain visible. The support PCB (7) of the lighting assembly is single-sided and is provided with a printed circuit only on the front side (70). However, the PCB (7) can also be double-sided.

In particular, said printed circuit obtained on the front side (70) of the PCB (7) comprises pads (72) whereon LED's (5) and conductive tracks (73) connecting said pads (72) are mounted.

The PCB (7) of the lighting assembly comprises a notch (74) with two metallizations that are insulated and connected to the tracks (73) of the PCB (7) of the lighting assembly. In view of the above, by coupling the notch (36) of the connection PCB and the notch (74) of the lighting assembly PCB, the two metallizations of the notch (36) of the connection PCB come in contact with the two metallizations of the notch (74) of the lighting assembly PCB and are soldered.

Consequently, electrical current passes from the conductive tracks (32, 33) of the connection PCB (3) to the conductive tracks (73) obtained on the printed circuit of the PCB (7) of the lighting assembly (4).

Optionally, the lamp (100) can comprise a bracket (8) adapted to connect the connection PCB (3) to the lighting assembly PCB (7). The bracket (8) must be made of insulating material and must comprise two conductive tracks or electrical wires to transmit electrical current for power supply from the connection PCB (3) to the lighting assembly PCB (7).

For example, the bracket (8) has a rectangular shape and two ends. The ends of the bracket (8) are provided with notches (80) and (81) adapted to be respectively coupled with the notches (36, 74) of the connection PCB and the lighting assembly PCB.

Each notch (80, 81) of the bracket has two metallizations that are insulated and connected to the two conductive tracks of the bracket.

Alternatively, instead of the lighting assembly PCB (7), an ordinary lamp-holder for incandescent or halogen lamp can be provided.

Numerous variations and modifications can be made to the present embodiments of the invention, within the reach of an expert of the art, while still falling within the scope of the invention described in the enclosed claims.

1. A lamp (100) comprising:
a base PCB;
at least one support PCB connected to the base PCB; and
a lighting assembly connected to the support PCB and comprising at least one light source;
wherein said base PCB comprises two conductive tracks connected to an electrical power supply and ending in two electrical contacts in contact with corresponding first electrical contacts of said at least one support PCB;
said at least one support PCB comprises at least one conductive track connected to said first electrical contact of the support PCB and ending in a second electrical contact of the support PCB;
said second electrical contacts of said at least one support PCB being electrically connected with corresponding electrical contacts of said lighting assembly;
wherein said electrical contacts of the base PCB and of said at least one support PCB are conductive metallizations obtained around a hole of the base PCB and around a first hole and a second hole of the support PCB, which come in contact and establish the electrical connection between the tracks of the base PCB and the tracks of the support PCB.

2. The lamp of claim 1, comprising a threaded plug inserted into said hole of the base PCB and in said first hole of said at least one support PCB and at least one pin provided with threaded hole whereon said plug is screwed, wherein said threaded plug and said at least one pin are made of non-conductive material.

3. The lamp of claim 1, also comprising a connection PCB arranged between said at least one support PCB and said lighting assembly, said connection PCB being provided with two conductive tracks connected to two electrical contacts in contact with said electrical contacts of said at least one support PCB, said conductive tracks ending in two electrical contacts of the connection PCB coupled with said electrical contacts of the lighting assembly, wherein said electrical contacts of the connection PCB and said electrical contacts of said at least one support PCB are metallizations obtained around a hole of the connection PCB and around said second hole of said at least one support PCB.

4. The lamp of claim 3, also comprising a screw inserted into said hole of the connection PCB and in said second hole of said at least one support PCB and one metal ring provided with threaded hole whereon said screw is screwed, said screw and said metal ring being made of non-conductive material.

5. The lamp of claim 1, also comprising an integrated circuit supported by the base PCB and acting as power supply for said lighting assembly, said integrated circuit comprising outputs connected to said conductive tracks of the base PCB.

6. The lamp of claim 1, comprising two support PCB's, each support PCB being provided with a single conductive track connecting the first electrical contact with the second electrical contact.

7. The lamp of claim 1, wherein said base PCB is of double side type, comprising a front side and a back side, and wherein a first conductive track is obtained on the front side and a second conductive track is obtained on the back side.

8. The lamp of claim 1, wherein said connection PCB is of double side type, comprising a front side and a back side and wherein a first conductive track is obtained on the front side and a second conductive track is obtained on the back side.

9. The lamp of claim 1, wherein said lighting assembly comprises a PCB comprising pads whereon said at least one light source and conductive tracks connecting said pads are mounted.

10. The lamp of claim 1, wherein said base PCB comprises a switch to switch said at least one light source on and off, which is obtained as touch button integrated in said base PCB.
